(19) United States
(12) Patent Application Publication
(10) Pub. No.: US 2022/0095753 A1
(43) Pub. Date: Mar. 31, 2022

(54) Mobility Cane with Improved Handling Features

(71) Applicants: Elizabeth Adele MEHL, Portland, OR (US); Finn Fergus KINNELL, Portland, OR (US)

(72) Inventors: Elizabeth Adele MEHL, Portland, OR (US); Finn Fergus KINNELL, Portland, OR (US)

(73) Assignee: Stone Table Mobility LLC, Portland, OR (US)

(21) Appl. No.: 17/033,838

(22) Filed: Sep. 27, 2020

(51) Int. Cl. A45B 9/02; A61H 3/02; A45B 7/00; A45B 9/04

(52) U.S. Cl. CPC A45B 9/02; A61H 3/0288; A45B 2009/005; A45B 9/04; A45B 7/00

(57) ABSTRACT

Mobility assistive devices in the nature of canes, staffs or walking sticks are constructed with a bent or “dog-leg” shape so that an upper portion of the cane adjacent the handle extends forward in the direction of travel of the cane's user and is visible in her peripheral vision. The shape of the cane and the proprioceptive feedback from its motion convey more information to the user and allow more confident, efficient motion than a traditional straight cane or staff. Some embodiments include rotating joints to allow the cane to be folded when not in use.

### CONTINUITY AND CLAIM OF PRIORITY

This is an original U.S. patent application.

### FIELD

The invention relates to walking sticks, walking aids and canes for assisting disabled individuals. More specifically, the invention relates to appliances having particular physical characteristics for aiding patients or disabled persons to walk about.

### BACKGROUND

Individuals with balance, strength and bodily-configuration infirmities often rely on assistive devices to help them move about in environments that may be better suited to individuals unburdened by such physical challenges. Accessibility features provided by the environment (e.g., handrails and ramps) make it easier for disabled individuals to move around, but devices that such an individual can carry with her are nonetheless helpful—and may be critical in locations where handrails, ramps and the like have not been provided.

Canes, walking sticks, crutches and similar devices are old and well-known, but modern materials and manufacturing techniques allow the construction of new mobility devices with different configurations and usability features. These advanced devices may be of substantial value in this field.

### SUMMARY

A mobility assistive device according to an embodiment is in the nature of a traditional cane, but it has a bent or “dog-leg” configuration that provides improved performance and security for its user. Some devices also include a novel folding mechanism comprising rotating joints between adjacent segments, so that the cane can be folded into a shorter configuration for easier transport. Other features and characteristics of the inventive cane are described below.

### BRIEF DESCRIPTION OF DRAWINGS

FIGS. 1A and 1B show an exemplary embodiment from two different perspectives.

FIGS. 2A and 2B show a not-to-scale embodiment with various lengths, angles and other measurements identified and specific terminology set forth.

FIG. 3 shows an embodiment of the invention.

FIG. 4 shows how the embodiment of FIG. 3 may be folded.

FIG. 5 shows several folding embodiments in varying states of opening or closing.

FIG. 6 shows how an exemplary embodiment moves during a typical step by a user.

FIG. 7 shows another way of characterizing the distinguishing features of an embodiment.

### DETAILED DESCRIPTION

An embodiment of this invention is a mobility assistive device in the nature of a cane or walking stick. Significant distinguishing features include an angled “dog-leg” shape and, in many embodiments, a collapsible feature where several segments of the cane may be folded at rotating joints to reduce the size of the cane for easier storage or transport.

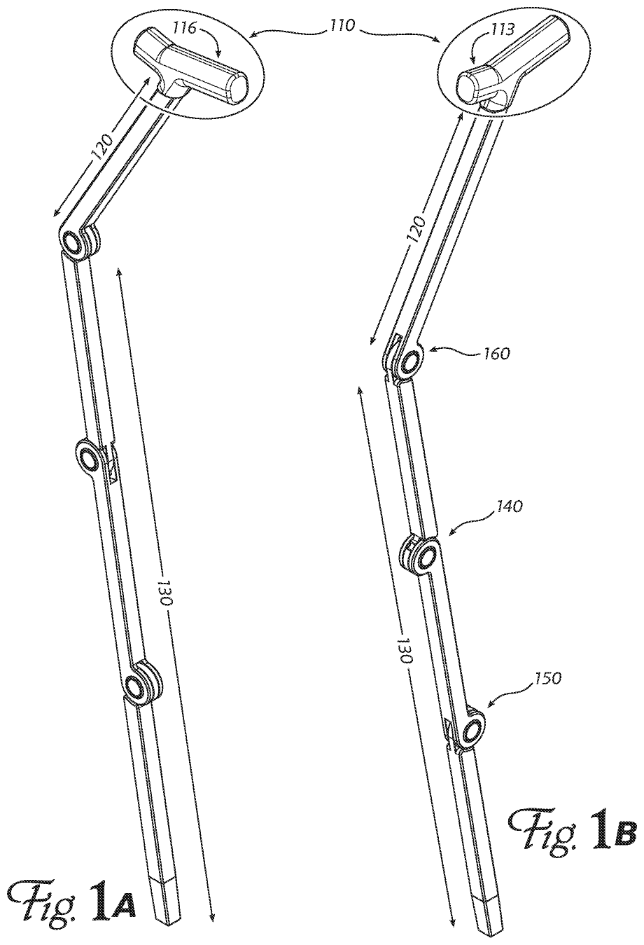

FIG. 1A shows an exemplary embodiment from a right-handed user's perspective, from slightly above and behind the device. The embodiment includes a handle portion 110 at an upper extremity, and a strong staff portion extending from the handle 110 to the lower extremity. The staff includes at least two subsections, 120 and 130, which are set at an angle to one another, so that the staff portion has a dog-leg shape.

FIG. 1B shows the same embodiment from a different perspective (slightly above and ahead of the device). The lower portion of the staff 130 comprises two rotating, locking joints 140 and 150; and a similar rotating and locking joint 160 connects the upper subsection of the staff 120 to the lower subsection 130. (The lower subsection is further divided by the locking joints 140 and 150, but the joints lock at 180° and so the entire subsection—when locked—is straight.)

The embodiment depicted in these Figures has a T-shaped handle 110 with a first knob 113 that may rest in the user's hand adjacent the thumb; and a second knob 116 that may rest in the user's palm and be grasped by the user's fingers. A T-shaped handle allows the user to apply torque to and through the embodiment, to orient the “knee” of the dog-leg in a way that facilitates its use, as described below. Of course, the handle must also be easily graspable by the user, and a user with impaired dexterity or an injured (or missing) hand may require a different interface. Thus, an embodiment may be constructed with a spherical (or other shaped) handle, or even with a mechanical apparatus suitable to complement the structure of a prosthetic hand or forearm, for a user with such a requirement.

Regarding Anthropometry

Embodiments of the invention are assistive devices that are heavily affected by the size, shape and configuration of the user's body—similarly to clothing. Thus, descriptions that rely on absolute lengths, angles and other measurements are not especially effective to convey the essential or significant characteristics of an embodiment; these values vary over as wide a range as the bodies of the users themselves. Consequently, the present disclosure will often provide descriptions in terms of self-referential ratios or proportions (e.g., the upper and lower subsections of an embodiment may have a length ratio from about 2.5:1 to about 3.5:1 [the lower segment is 2.5 to 3.5 times as long as the upper segment]).

However, it is also helpful to describe characteristics of an embodiment by reference to a size, shape, posture or movement of the user. For example, many users find a cane according to an embodiment which is from about 40% of the user's height, to about 55% of the user's height, to be comfortable and to have favorable handling characteristics. Therefore, characteristics of an embodiment may also be described by reference to measurements, ratios or proportions of the user thereof.

When a body size, shape, posture or movement is discussed, Applicants will base such comments on the extensive anthropometry data collected by the National Aeronautics and Space Administration (“NASA”) and published as the Human Integration Design Handbook (HIDH), NASA/SP-2010-3407/REV1, which is incorporated in its entirety by this reference. It is appreciated that the HIDH is not especially concerned with the non-standard body configurations that many users of assistive devices may exhibit, but for expository and explanatory purposes, the anthropometry of HIDH provides a well-known, consistent reference that should help avoid indefiniteness. Users of an embodiment will, of course, choose a device that is proportioned to suit their needs exactly, in the same manner that individuals choose clothes that fit them, rather than clothes that fit a hypothetical standard person of the same height and weight.

### Glossary

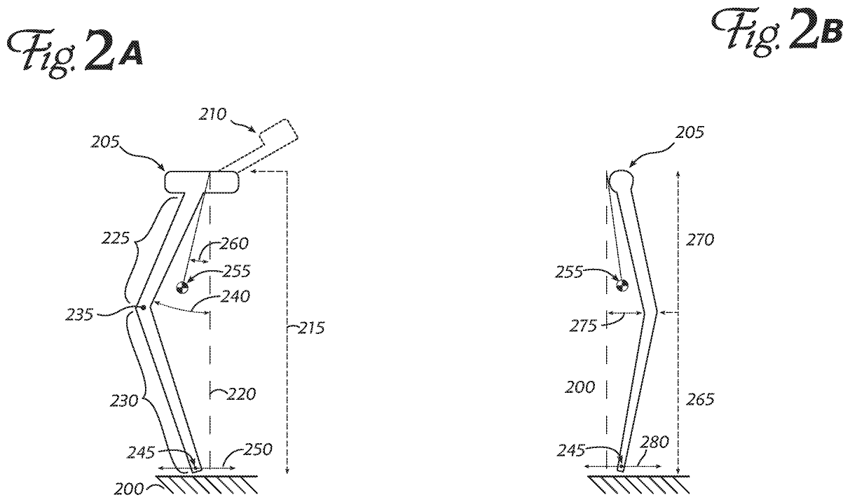

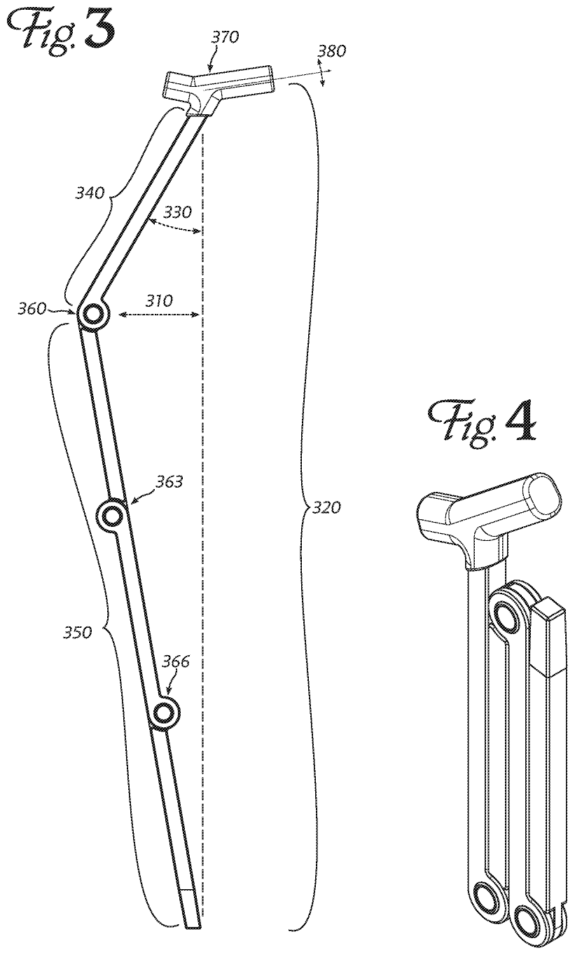

FIGS. 2a and 2b show side and rear views (respectively) of a generic embodiment in a standard orientation and attitude. The figures are not to scale, but are exaggerated and somewhat unrealistically proportioned to allow easier identification of particular areas of interest. The terms used in the following discussion to refer to parts of an embodiment have the following meanings (unless a variant meaning is specifically stated at a particular point):

Side view 2A depicts a generic embodiment standing vertically on a ground plane 200. The cane is oriented as it would be used to walk from right to left. At an upper extremity of the embodiment is a handle 205. (An embodiment may have structure above the handle 205, such as a forearm brace 210, but the height of an embodiment will refer to the distance 215 of the handle 205 above the ground, 200.) Some distances and angles will be given with reference to a vertical axis 220 that is perpendicular to the ground 200.

An embodiment comprises an upper segment 225 and a lower segment 230 which meet at a knee 235. The upper segment 225 is angled forward (in the direction of travel) from the vertical 220 by an angle 240. The lower segment 230 is angled back from the knee 235 to a toe of the cane at 245. The toe 245 may rest on the ground normally either ahead or behind the vertical, as indicated at 250, although for many descriptions it is convenient to position the cane so that the midpoint of the handle 205, near the center of the user's palm when holding the cane, is directly over the toe 245.

This arrangement of elements leads to the center of gravity of the cane, 255, lying between the knee 235 and the vertical 220, at an angle 260 from the vertical. It is appreciated that the aforementioned elements can equivalently be specified in terms of lengths or ratios of lengths, distances or proportional distances above the ground and below the handle, or as angles between adjacent elements although the angles and other distances may not be specifically identified in this figure.

Turning to FIG. 2B, a rear view of the generic embodiment is shown (the user of the cane in this view would be walking into the paper). The handle 205 is shown at the same height 215, but this figure illustrates how the location of the knee 235 may be specified as the distance 265 from the ground 200 to the knee 235, and the distance 270 from the knee 235 to the handle 205 (or as a ratio of those two distances, or a distance as a proportion of the total height 215).

This view shows how the knee 235 may be displaced laterally 275 from the vertical, and how the toe 245 may be located left or right 280 as it contacts the ground 200. As with the fore/aft arrangement in FIG. 2a, the lateral arrangement shown in FIG. 2b implies that the center of gravity 255 may be displaced laterally from the plane containing the handle 205 and the toe 245, and set parallel to the direction of travel (perpendicular to the page).

Most embodiments of the invention comprise a forward displacement of the knee in the direction of travel, but some embodiments do not include any lateral displacement of the knee as shown in FIG. 2B. In other words, the rear (and front) view of some embodiments show that the handle, knee, center of gravity and toe are all on a vertical line perpendicular to the ground.

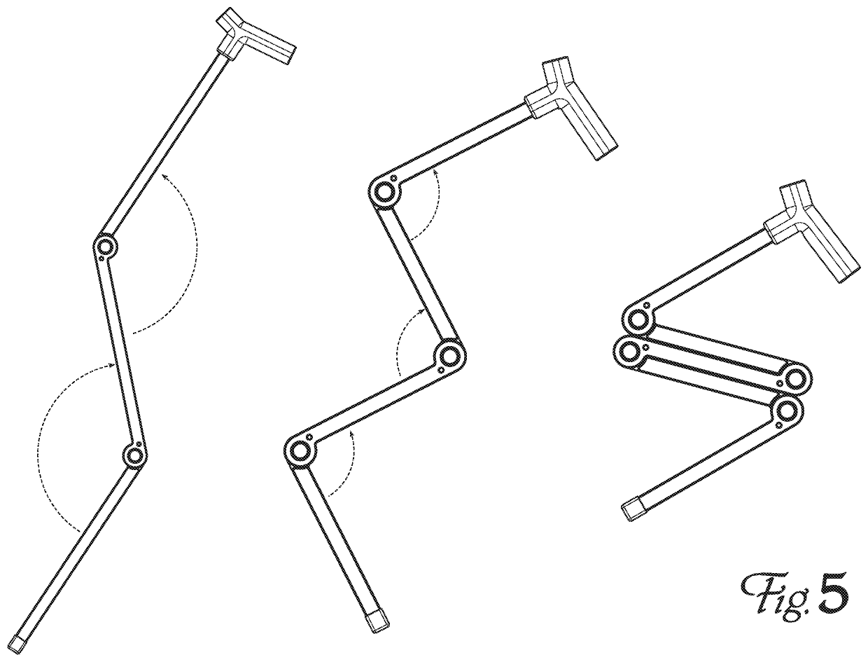

With the foregoing terms and parameters in mind, we turn to FIG. 3, which shows a side view of the embodiment shown in perspective in FIGS. 1A and 1B. The knee 360 of this embodiment is displaced to the left 310 (forward) by about 1/7 of the overall height 320. (This corresponds to a forward angle of about 30°, 330, from the vertical.) The ratio of the lengths of the upper segment, 340, to the lower segment, 350, is about 1:2.5. The rotating joints identified at 360, 363 and 366 lock in the positions shown, or can be rotated to closed position to fold the cane as shown in FIG. 4. Lower-segment joints 363 and 366 may lock only in the fully open or fully closed positions, while joint 360 may have several locking positions near the angle shown in FIG. 3 to adjust the angle between the upper and lower segments over a predetermined range. In some embodiments, handle 370 may be angularly adjustable relative to the upper segment 340 as indicated by 380.

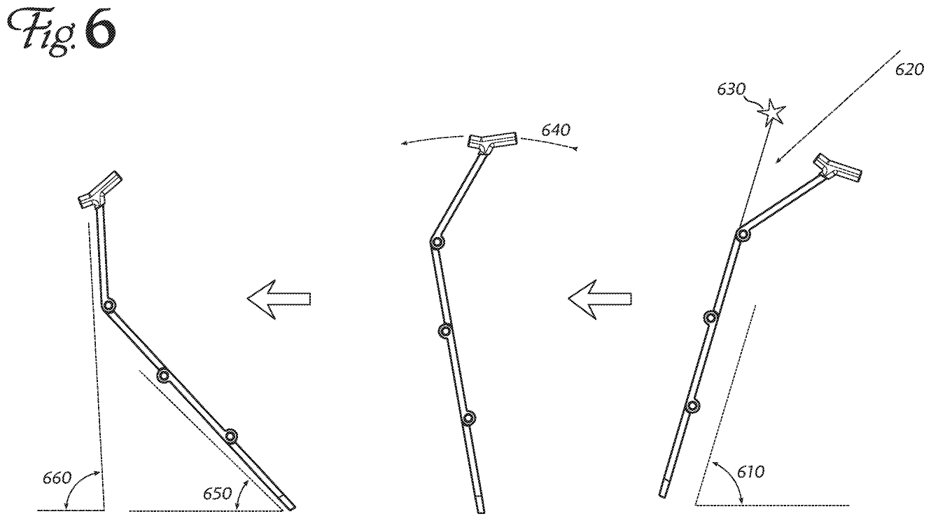

In a collapsible or foldable embodiment, it is preferable that each folding segment be approximately the same length, so that the folded embodiment is as short as possible. Embodiments may comprise a variety of number of segments, such as three (3), four (4) or five (5) segments, as shown in FIG. 5. (Canes shown in varying states of collapse.) As shown by the dashed arrows, each pair of adjacent segments is coupled by a rotating joint that allows the segments to rotate in the plane formed by the segments and the joint. Each joint rotates in an opposite direction from its neighbor(s) so that the entire cane can fold up with little wasted space (see FIG. 4). Joints should lock securely when the segments are at 180° (when the cane is extended for use), and may have a weak lock at the fully-closed position so that a collapsed cane tends to stay folded up until the user specifically unfolds it. The first joint below the handle may lock at an angle smaller than 180° (e.g., about 150°) causing the uppermost segment to angle forward from the vertical according to an embodiment of the invention. The less-than-180° joint forms the knee of such an embodiment, while the segments below the uppermost (locked at 180° to each other) form the straight lower segment of an embodiment, traveling from the knee to the toe.

A foldable embodiment thus has two stable configurations (securely locked open and ready for use; and weakly locked closed, in the fully folded condition); and a range of intermediate configurations where adjacent segments are in the process of being folded or unfolded. A foldable embodiment consists of n (an integer) segments connected together by (n−1) rotating joints, with a handle at one end and the toe of the cane at the other. The segments coupled by rotating joints form something like a chain, where each segment is a link, and the segments can be folded together at the joints or straightened out to form a straight or dog-leg cane.

It is appreciated that, although the segments of a folding embodiment are preferably the same length, they need not be the same weight (mass). Having segments of different weight allows the center of gravity of an embodiment to be moved up or down, forward or back, or even side to side (if the knee is displaced laterally from the direction of travel), to tune the proprioceptive feedback created by the cane during use. A heavier or lighter handle, or rotating joints of different weights, may similarly be used to adjust the position of the center of gravity.

FIG. 6 shows how an assistive device according to an embodiment may move during use, as the user walks from right to left. At the beginning of an assisted stride, the user advances the toe of the cane so that the lower segment is perpendicular to the ground, or slightly beyond that (610). Because of the extended knee shape, the user is able to see the knee in her peripheral vision 620 and perceive how the lower portion of the cane is oriented in space. In some embodiments, an extension at the upper end of the lower segment includes an eye-catching marker 630 to assist in perceiving the orientation of the lower portion of the cane.

After planting the toe of the cane, the user steps forward and the handle moves in an arc 640, providing a stable support for the user's perambulation. Finally, as the upper segment of the cane passes the normal to the ground 660 (and the lower segment is well past the normal, 650), the user begins a step with the other leg (she may carry another similar cane in the other hand and use them in alternation).

In addition to the peripheral visibility of the upper segment and the knee, it is believed that the shape of the cane and its center of gravity are effective to provide proprioceptive feedback to the user and improve her handling of the cane and enhance the level of trust in the support it provides. This improved handling and feedback may be especially valuable to users with reduced strength and/or balance difficulties.

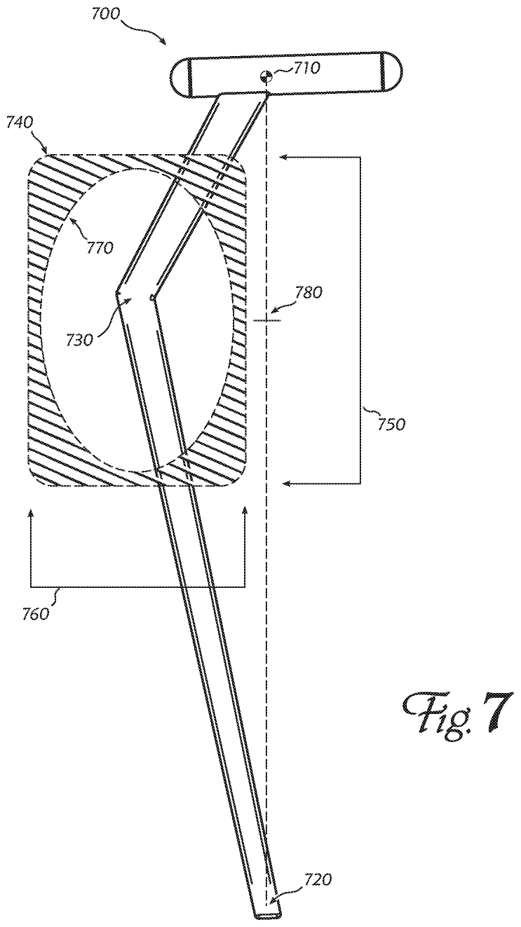

FIG. 7 shows another embodiment of the invention 700. This embodiment is non-collapsible (it has no rotating joints or other mechanisms to fold up or reduce in size). When placed so that the central area of the handle (710, located approximately where a user's hand would grasp the handle during use) is directly over the toe 720, the knee 730 lies within a rectangular area 740 whose vertical dimension 750 is about 40% of the cane's height, and whose horizontal dimension 760 is about 25% of the cane's height. Preferably, the knee 730 lies in the oval area 770 that is bounded by rectangle 740. The center of the rectangle should lie at about ⅔ of the cane's height 780, and the rectangle should lie fully ahead of the vertical line between handle 710 and toe 720 (where “ahead” refers to the direction in which the user walks with the cane—right to left in this instance).

The applications of the present invention have been described largely by reference to specific examples and in terms of distinct physical characteristics, which may be combined differently than shown here. Those of skill in the art will recognize that mobility assistive devices in the nature of canes can also be constructed with different combinations of the features discussed. Such variations are understood to be captured according to the following claims.

1. A cane comprising:
a handle;
an upper segment coupled to the handle and to a knee;
a lower segment coupled to the knee and extending to a toe, the cane having a height measured in a straight line from the handle to the toe, wherein
a length of the lower segment is between 2.5 and 3.5 times a length of the upper segment; and
when the cane is oriented so that the handle is directly above the toe, the knee is displaced horizontally from the straight line by a distance of about 1/7 of the height of the cane.

2. The cane of claim 1 wherein the knee is displaced horizontally from the straight line in a direction of travel of a user holding the handle in the user's hand.

3. The cane of claim 1 wherein the knee is displaced horizontally from the straight line in a direction perpendicular to direction a of travel of a user holding the handle in the user's hand.

4. The cane of claim 1 wherein the handle has a “T” shape.

5. The cane of claim 1, further comprising:
a forearm brace coupled to an upper extremity of the cane near the handle.

6. The cane of claim 1, further comprising:
a rotating joint coupled between the upper segment and the lower segment at the knee, wherein
the rotating joint has a first locking position with the upper segment immediately adjacent the lower segment, and
the rotating joint has a second locking position with the upper segment at an angle to the lower segment,
said second locking position placing the knee at a horizontal displacement of about 1/7 of the height of the cane from the straight line.

7. A cane comprising:
n segments of similar length, n is an integer greater than one (1);
(n−1) rotating joints joining the n segments together end-to-end into a chain so that each rotating joint couples exactly two of the n segments; and
a handle coupled to one end of the chain, wherein
each rotating joint allows a pair of segments attached thereto to rotate in a plane of the pair of segments and the joint, between a closed position where the pair of segments are side-by-side, to an open position where an angle between the pair of segments is between 150° and 180°.

8. The cane of claim 7 wherein n is three (3), four (4) or five (5).

9. The cane of claim 7 wherein a rotating joint nearest the handle locks at about 150°.

10. The cane of claim 7 wherein each of the n segments is approximately a same weight.

11. The cane of claim 7 wherein a weight of the n segments varies.

12. The cane of claim 7 wherein when all (n−1) joints are locked in the open position, the cane forms a substantially straight shape between the handle and a toe at a most-remote segment end from the handle.

13. The cane of claim 7 wherein when all (n−1) joints are locked in the open position, the cane forms a dog-leg shape with a knee of the dog-leg at about ⅔ of a height of the cane.

14. A mobility assistive device comprising:
a handle;
an upper segment coupled to the handle and extending forward at an angle of about 30° to a vertical reference line, said upper segment descending to about ⅔ of a height of the mobile assistive device; and
a lower segment coupled to a lower end of the upper segment and extending back to a toe of the mobile assistive device at a bottom end thereof, said toe resting directly under the handle.

15. The mobility assistive device of claim 14 wherein the handle is a T-shaped structure at an upper end of the upper segment.

16. The mobility assistive device of claim 14 wherein the handle is a spherical structure at an upper end of the upper segment.

17. The mobility assistive device of claim 14 wherein the handle is a mechanical interface adapted to couple to a prosthetic arm of a user.

18. The mobility assistive device of claim 14 wherein the lower segment comprises:
a plurality of sub-segments coupled by rotating locking joints, wherein
the rotating locking joints permit the plurality of sub-segments to be folded adjacent each other; and
the rotating locking joints permit the plurality of sub-segments to be unfolded to form a lower segment that is substantially straight.
